(19) United States
(12) Patent Application Publication
(10) Pub. No.: US 2017/0190080 A1
(43) Pub. Date: Jul. 6, 2017

(54) COMPOSITE MATERIAL COMPOSED OF OUTER LAYER AND POLYURETHANE FOAM LAYER

(71) Applicant: BASF SE, Ludwigshafen (DE)

(72) Inventors: Gerd Rischko, Lemfoerde (DE); Jörg Pöltl, Lemfoerde (DE); Julio Albuerne, Lemfoerde (DE)

(73) Assignee: BASF SE, Ludwigshafen (DE)

(21) Appl. No.: 15/314,854

(22) PCT Filed: May 29, 2015
(86) PCT No.: PCT/EP2015/061935

§ 371 Date: Nov. 29, 2016

(30) Foreign Application Priority Data
Jun. 2, 2014 (EP) 14170794.3

(51) Int. Cl. B29C 44/12; C08G 18/76; C08G 18/79; B60R 13/02; B32B 5/20; B32B 27/06; B32B 27/30; C08G 18/08; C08G 18/48

(52) U.S. Cl. CPC B29C 44/12; C08G 18/14; C08G 18/7671; C08G 18/797; C08G 18/4816; B32B 5/20; B32B 27/065; B32B 27/304; B60R 13/02; C08G 2101/0083

(57) ABSTRACT

In a process for producing a composite element having at least a covering layer and polyurethane foam, the covering layer is inserted into a mold and a polyurethane reaction mixture is introduced onto the covering layer. The polyurethane reaction mixture is reacted to form a polyurethane foam, wherein the polyurethane reaction mixture is obtained by mixing a) polyisocyanate with b) compounds having isocyanate-reactive OH groups, c) blowing agents including water, d) thickeners and e) catalysts. Bis(N,N-dimethylaminoethoxyethyl) carbamate, N,N,N-trimethyl-N-hydroxyethylbis(aminopropyl ether), N,N,N-trimethyl-N-hydroxyethyl(aminoethyl ether) or mixtures thereof and/or tetramethyldiaminoethyl ether are employed as catalysts and the polyurethane foam has a density of not more than 200 g/dm³.

The present invention relates to a composite element made of at least a covering layer and polyurethane foam, where a covering layer is inserted into a mold and a polyurethane reaction mixture is introduced onto the covering layer and reacted to afford a polyurethane foam, wherein the polyurethane reaction mixture is obtained by mixing (a) polyisocyanate with (b) compounds having isocyanate-reactive OH groups, (c) blowing agents comprising water, (d) thickeners and optionally (e) catalysts and (f) other assistant and additive substances and the polyurethane foam has a density of not more than 200 g/dm³. The present invention further provides a process for producing such composite elements and for the use of the composite elements in the interior of means of transport.

Polyurethanes have manifold possible applications. They are often employed in particular in automobile manufacturing, for example in automobile exterior trim as spoilers, roof elements, suspension elements and in automobile interior trim as headliners, foam carpet backings, door trims, instrument panels, steering wheels, gear knobs and seat cushioning. These polyurethane foams are usually employed in the form of composites comprising a covering layer. These composites are typically produced by inserting the covering layer into a mold, applying the reaction mixture for producing the polyurethane foam and curing. Processes for producing these composites that are suitable for use in automobile interiors are described in EP 1361239 or DE 10 2005 011 572 for example.

There is a trend in the automobile industry for weight reduction of components. In the field of polyurethane foam this is typically achieved by a reduction in density and by a reduction in material thickness. Thinner polyurethane foams further leave more room, for example for wiring. However, the use of known systems for producing polyurethane foams exhibit processing problems in the case of low density and low component thickness since the material introduced into the molds no longer fills said molds in a defect-free fashion.

Further, the emissions of volatile compounds caused by polyurethanes employed in automobile interiors must be as low as possible. This is particularly important for composite components since the emitted compounds can result in changes to the material of the covering layer. The emitted compounds are moreover usually perceived as an odor nuisance. The emissions are often caused by the use of volatile, high-activity amine catalysts. In order to reduce emissions these high-activity catalysts are completely or partly replaced by incorporable catalysts. These compounds catalyze the polyurethane reaction but at the same time also have isocyanate-reactive groups which results in secure incorporation of the catalysts into the polyurethane. The need to use incorporable catalysts severely reduces the number of possible employable catalysts which makes it even more difficult to adapt the reaction profile.

It is accordingly an object of the present invention to provide an efficient process for producing composites made of a covering layer and a polyurethane foam which makes it possible to reduce the thickness, density or thickness and density of the polyurethane foams. It is a particular object to provide a process where incorporable amine catalysts are used as the amine catalysts. It is a further object to provide a lightweight composite component made of a covering layer and a polyurethane foam.

This object is achieved by a process for producing a composite element made of a covering layer and polyurethane foam, where a covering layer is inserted into a mold and a polyurethane reaction mixture is introduced onto the covering layer and reacted to afford a polyurethane foam, wherein the polyurethane reaction mixture is obtained by mixing (a) polyisocyanate with (b) compounds having isocyanate-reactive OH groups, (c) blowing agents comprising water, (d) thickeners and optionally (e) catalysts and (f) other assistant and additive substances and the polyurethane foam has a density of not more than 200 g/dm³. This object is further achieved by a composite element comprising a covering layer and a polyurethane foam obtainable by such a process.

The polyurethane foam has a density of not more than 200 g/dm³, preferably 50 to 180 g/dm³ and particularly preferably 60 to 150 g/dm³. It is preferable when the polyurethane foam is a semirigid polyurethane foam having a compressive stress at 10% relative deformation and/or DIN 53 421 compressive strength of 15 kPa to 80 kPa.

Typically employed as the covering layer are materials which impart a decorative exterior to the composite element, for example plastic films, plastic skins, textiles and/or leather. Preference is given to using PUR spray or cast or slush skins and/or PVC slush skins and thermoformed films made of thermoplastic materials. The thickness of the outer layer is generally 0.6 to 2 mm, preferably from 0.8 to 1.2 mm. In one embodiment of the invention the covering layers are produced in a separate operation and inserted into the mold. In a further embodiment the covering layers are produced in a first operation by applying the starting materials for producing the covering layer, for example a polyurethane reaction mixture or molten plastic, into the mold and subsequent curing to afford the covering layer before the reaction mixture for producing the polyurethane foam is introduced onto the covering layer.

The polyisocyanates (a) used for producing the integral polyurethane foams according to the invention comprehend the aliphatic, cycloaliphatic and aromatic di- or polyfunctional isocyanates known from the prior art (constituent (a-1) and also any desired mixtures thereof. Examples are 4,4′-methanediphenyl diisocyanate, 2,4′-methanediphenyl diisocyanate, the mixtures of monomeric methanediphenyl diisocyanates and higher-nuclear homologs of methanediphenyl diisocyanate (polymer MDI), tetramethylene diisocyanate, hexamethylene diisocyanate (HDI), isophorone diisocyanate (IPDI), 2,4- or 2,6-tolylene diisocyanate (TDI) or mixtures of the recited isocyanates.

Preference is given to using mixtures of 2,4′-MDI, 4,4′-MDI and polymer MDI. The preferably used MDI mixtures may comprise up to about 20 wt % of allophanate- or uretonimine-modified polyisocyanates. The proportion of higher-nuclear homologs of MDI is preferably 2 to 30 wt %, by preference 4 to 20 wt % and in particular 5 to 15 wt % in each case based on the total amount of the employed MDI in the component (a1).

The polyisocyanate component (a) may be employed in the form of polyisocyanate prepolymers. These polyisocyanate prepolymers are obtainable by reacting above-described polyisocyanates (a-1) with polyols (a-2) at temperatures of for example 30° C. to 100° C., preferably at about 80° C., to afford the prepolymer. Polyols (a-2) are known to one skilled in the art and described for example in “Kunststoffhandbuch, Band 7, Polyurethane”, Carl Hanser Verlag, 3rd edition 1993, chapter 3.1. It is preferable when the polyols described under b) are employed as the polyols (a-2). It is particularly preferable when polyethers, for example derived from ethylene oxide and/or propylene oxide, are employed as the polyols (a-2). Customary chain extenders or crosslinkers are optionally added to the recited polyols during production of the isocyanate prepolymers.

Compounds having isocyanate-reactive OH groups (b) comprise polyols. Polyols have a molecular weight of at least 300 g/mol and preferably comprise polyesterols and/or polyetherols.

Polyetherols are produced by known processes, for example by anionic polymerization with alkali metal hydroxides or alkali metal alkoxides as catalysts and with addition of at least one starter molecule comprising 2 to 3 reactive hydrogen atoms in bonded form or by cationic polymerization with Lewis acids such as antimony pentachloride or boron fluoride etherate from one or more alkylene oxides having 2 to 4 carbon atoms in the alkylene radical. Suitable alkylene oxides are for example tetrahydrofuran, 1,3-propylene oxide, 1,2- and 2,3-butylene oxide and preferably ethylene oxide and 1,2-propylene oxide. It is moreover also possible to employ multimetal cyanide compounds, so-called DMC catalysts, as catalysts. The alkylene oxides can be used individually, in alternating succession, or in the form of a mixture. Preference is given to mixtures of 1,2-propylene oxide and ethylene oxide, wherein the ethylene oxide is employed in amounts of 10% to 50% as an EO-cap so that the polyols formed have primary OH end groups to an extent of more than 70%.

Contemplated starter molecules are water or di- and trihydric alcohols, such as ethylene glycol, 1,2- and 1,3-propanediol, diethylene glycol, dipropylene glycol, 1,4-butanediol, glycerol or trimethylolpropane.

The polyether polyols, preferably polyoxypropylene-polyoxyethylene polyols, preferably have a functionality of 2 to 5, particularly preferably 2 to 4 and more preferably 2 to 3 and molecular weights of 500 to 10 000, preferably of 1000 to 8000 g/mol and particularly preferably of 2000 to 6000 g/mol.

Polyester polyols may for example be produced from organic dicarboxylic acids having 2 to 12 carbon atoms, preferably aliphatic dicarboxylic acids having 4 to 6 carbon atoms and polyhydric alcohols, preferably diols, having 2 to 12 carbon atoms, preferably 2 to 6 carbon atoms. Contemplated dicarboxylic acids are for example: succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids may be used either individually or in admixture with one another. Instead of the free dicarboxylic acids it is also possible to employ the corresponding dicarboxylic acid derivatives, for example dicarboxylic esters of alcohols having 1 to 4 carbon atoms or dicarboxylic anhydrides. It is preferable to use dicarboxylic acid mixtures of succinic acid, glutaric acid and adipic acid in quantitative ratios of for example 20 to 35:35 to 50:20 to 32 parts by weight and in particular adipic acid. Examples of di- and polyhydric alcohols, in particular diols are: ethanediol, diethylene glycol, 1,2- and 1,3-propanediol, dipropylene glycol, 1,4-butanediol, 1,5-pentanediol, 1,6-hexanediol, 1,10-decanediol, glycerol and trimethylolpropane. It is preferable to use ethanediol, diethylene glycol, 1,4-butanediol, 1,5-pentanediol and 1,6-hexanediol. It is further possible to employ polyester polyols formed from lactones, for example ε-caprolactone or hydroxycarboxylic acids, for example ω-hydroxycaproic acid.

The obtained polyester polyols preferably have a functionality of 2 to 4, in particular of 2 to 3, and a molecular weight of 500 to 3000, preferably 1000 to 3000, g/mol.

Suitable polyols further include polymer-modified polyols, preferably polymer-modified polyesterols or polyetherols, particularly preferably graft polyetherols and graft polyesterols, in particular graft polyetherols. At issue here is a so-called polymer polyol which typically has a content of, preferably thermoplastic, polymers of 5 to 60 wt %, preferably 10 to 55 wt %, particularly preferably 30 to 55 wt % and in particular 40 to 50 wt %. These polymer polyesterols are described in WO 05/098763 and EP-A-250 351 for example and are typically produced by free-radical polymerization of suitable olefinic monomers, for example styrene, acrylonitrile, (meth)acrylates, (meth)acrylic acid and/or acrylamide in a polyesterol which serves as a graft substrate. The side chains are generally formed by transfer of the free radicals from growing polymer chains onto polyesterols or polyetherols. In addition to the graft copolymer the polymer polyol predominantly comprises the homopolymers of the olefins, dispersed in unchanged polyesterol/polyetherol.

In a preferred embodiment acrylonitrile, styrene, acrylonitrile and styrene, especially preferably exclusively styrene, are used as monomers. The monomers are optionally polymerized in the presence of further monomers, a macromer, or a moderator and using a free-radical initiator, usually azo compounds or peroxide compounds, in a polyesterol or polyetherol as continuous phase. This process is described in DE 111 394, U.S. Pat. No. 3,304,273, U.S. Pat. No. 3,383,351, U.S. Pat. No. 3,523,093, DE 1 152 536 and DE 1 152 537 for example.

The macromers are concomitantly incorporated into the copolymer chain during the free-radical polymerization. This results in the formation of block copolymers having a polyester or, respectively, polyether block and a poly(acrylonitrile-styrene) block, which act as compatibilizers at the interface between the continuous phase and the disperse phase and suppress the agglomeration of the polymer polyesterol particles. The proportion of macromers is typically 1 to 20 wt % based on the total weight of the monomers used for preparing the polymer polyol.

If polymer polyol is present in the compounds having isocyanate-reactive OH groups (b) then this is preferably present together with further polyols, for example polyetherols, polyesterols or mixtures of polyetherols and polyesterols. It is particularly preferable when the proportion of polymer polyol is greater than 5 wt % based on the total weight of the component (b). The polymer polyols may be present for example in an amount of 7 to 90 wt % or of 11 to 80 wt % based on the total weight of the component (b). It is particularly preferable when the polymer polyol is polymer polyesterol or polymer polyetherol.

In addition to polyols the compounds having isocyanate-reactive OH groups (b) according to the invention may further comprise chain extenders and/or crosslinkers. The chain extenders are typically dihydric alcohols having molecular weights from 60 g/mol to 299 g/mol, for example ethylene glycol, propylene glycol, 1,4-butanediol, 1,5-pentanediol. The crosslinking agents are typically compounds having molecular weights from 60 g/mol to 299 g/mol and 3 or more isocyanate-active hydrogen atoms which in addition to OH groups may for example also comprise primary or secondary amino groups and particularly preferably comprise exclusively OH groups, for example glycerol, triethanolamine, trimethylolpropane and/or pentaerythritol. It is preferable to employ crosslinkers having a functionality towards isocyanates of 3 and an OH number of greater than 900 mg KOH/g, preferably greater than 1200 mg KOH/g, particularly preferably greater than 1400 mg KOH/g. The use of these crosslinkers makes it possible to achieve a good breaking extension coupled with low density and sufficient hardness. Preferably employed crosslinkers are glycerol and/or triethanolamine and/or trimethylolpropane. Provided that chain extenders, crosslinkers or mixtures thereof are used for producing the polyurethane foams, these are advantageously used in an amount from 0 to 20 wt %, preferably from 1 to 8 wt %, based on the total weight of the polyols (b).

It is preferable when the compounds having isocyanate-reactive OH groups (b) comprise polyether alcohol bi) which is obtainable by addition of alkylene oxides onto aliphatic compounds having at least one tertiary amino group. The polyether alcohols bi) are produced by reaction of aliphatic compounds having at least one tertiary amino group in the molecule with alkylene oxides. It will be appreciated that the recited compounds must comprise at least one, preferably at least two, functional groups that may be reacted with alkylene oxides. These may in particular be hydroxyl groups or primary or secondary amino groups. The recited aliphatic compounds having at least one tertiary amino group in the molecule preferably have a molecular weight of not more than 400 g/mol. It is preferable to employ compounds typically employed as incorporable catalysts in the production of polyurethanes. The aminic starting substance for producing the polyether alcohols bi) is preferably selected from the group comprising dimethylaminoethylamine, N,N-dimethylaminopropylamine, diethylaminoethylamine, diethylaminopropylamine, N-(3-dimethylaminopropyl-N,N-diisopropanolamine, dimethylethanolamine, N,N,N′-trimethyl-N′-hydroxyethylbis(aminoethyl) ether, N,N-bis(3-dimethylaminopropyl)amino-2-propanolamine, bis(N,N-dimethyl-3-aminopropyl)amine, N,N-dimethylaminoethoxyethanol, N-(3-aminopropyl)imidazole, N-(2-dimethylaminoethyl)-N-methylethanolamine, N-(2-hydroxypropyl)imidazole, dimethylaminohexanol and mixtures of at least two of the recited compounds.

The process for producing the polyether alcohols bi) is preferably conducted such that on average 1 to 8, preferably 1 to 6, in particular 2 to 4, molecules of the alkylene oxide are added onto each active hydrogen atom of the aminic starting substance. Typically employed alkylene oxides are ethylene oxide, propylene oxide and mixtures of ethylene oxide and propylene oxide. Polyols bi) are described in DE 10 2005 011 572 for example.

Component b) preferably comprises at least 4 wt % of polyether alcohol bi) based on the weight of the component b). A lower content of polyether alcohol bi) does not provide a significant effect. It is particularly preferable when the content of polyether alcohol bi) is 4 to 50 wt %, in particular 4 to 20 wt %, in each case based on the total weight of the component b).

Employed as blowing agent (c) for the process according to the invention is water which reacts with isocyanate groups to form carbon dioxide. The amounts of water advantageously used are 0.1 to 8 parts by weight, preferably 1.2 to 5 parts by weight, based on 100 parts by weight of component b) depending on the desired density of the foams.

It is optionally also possible to employ so-called physical blowing agents in admixture with water. These are liquids which are inert toward the formulation constituents and have boiling points below 100° C., preferably below 50° C., in particular between −50° C. and 30° C., at atmospheric pressure so that they evaporate under the influence of the exothermic polyaddition reaction. Examples of such preferably usable liquids are hydrocarbons, such as pentane, n- and isobutane and propane, ethers, such as dimethyl ether and diethyl ether, ketones, such as acetone and methyl ethyl ketone, ethyl acetate and preferably halogenated hydrocarbons, such as methylene chloride, trichlorofluoromethane, dichlorodifluoromethane, dichloromonofluoromethane, dichlorotetrafluoroethane and 1,1,2-trichloro-1,2,2-trifluoroethane. Mixtures of these low-boiling liquids with one another and/or with other substituted or unsubstituted hydrocarbons may also be used. Carbon dioxide too may be employed as blowing agent and is preferably dissolved in the starting components as a gas. The amount of physical blowing agents required in addition to water may be determined in simple fashion depending on the desired foam density and is approximately 0 to 50 parts by weight, preferably 0 to 20 parts by weight, per 100 parts by weight of polyhydroxyl compound. In one particularly preferred embodiment water is employed as the sole blowing agent (c).

Thickeners (d) employed are substances which rapidly increase the viscosity of the reaction mixture after the mixing of the components (a) to (f) while retaining the flowability of the reaction mixture. This is achieved by compounds having molecular weights of less than 500 g/mol and two isocyanate-reactive groups which are more reactive in the reaction with isocyanate than the isocyanate-reactive groups of the compounds from component (b). Generally, primary OH groups are more reactive than secondary OH groups and amino groups are more reactive than OH groups. Thickeners (d) ensure that isocyanates preferentially react with the thickeners. This leads to a rapid molecular weight increase and thus to a rapid viscosity increase but not to a crosslinking or to molecules which on account of their large molecular weight result in a curing. It is preferable when the thickeners (d) have a molecular weight of 58 to 300 g/mol, particularly preferably 100 to 200 g/mol. The thickeners (d), being isocyanate-reactive groups, preferably have two primary amino groups. In a particularly preferred embodiment the primary amino groups are bonded to aromatic carbon atoms, preferably to an aromatic 6-membered ring, in particular in the meta or para position. As thickener (d), in particular diethylenetoluenediamine (DETDA), in particular DETDA 80, is employed. Diethylenetoluenediamine is commercially available, for example from Lonza or Abemarle.

Catalysts (e) strongly accelerate the reaction of the polyols (b) and chemical blowing agent (c) with the polyisocyanates (a). These catalysts (e) preferably comprise incorporable amine catalysts. The incorporable catalysts employed in the present invention are bis(N,N-dimethylaminoethoxyethyl) carbamate, N,N,N-trimethyl-N-hydroxyethylbis(aminopropyl ether), N,N,N-trimethyl-N-hydroxyethyl(aminoethyl ether) or mixtures thereof.

Instead of or in addition to the incorporable amine catalysts it is also possible to employ tetramethyldiaminoethyl ether as catalyst.

In a particularly preferred embodiment exclusively incorporable catalysts are employed as catalyst (e).

When catalysts (e) are employed these may be employed for example in a concentration of 0.001 to 5 wt %, in particular 0.05 to 2 wt %, as a catalyst/catalyst combination based on the weight of the component (b).

Assistants and/or additive substances (f) may further be employed. All assistant and additive substances known for the production of polyurethanes may be employed. Mention may be made for example of surface-active substances, foam stabilizers, cell regulators, release agents, fillers, dyes, pigments, flame retardants, hydrolysis control agents, fungistatic and bacteriostatic substances. Such substances are known and described for example in “Kunststoffhandbuch, Band 7, Polyurethane”, Carl Hanser Verlag, 3rd edition 1993, chapter 3.4.4 and 3.4.6 to 3.4.11.

In the industrial production of polyurethane foams it is customary to combine the compounds having at least two active hydrogen atoms and the further input materials and also assistant and/or additive substances prior to the reaction to afford a so-called polyol component.

To produce the products according to the invention the isocyanates (a) and the isocyanate-reactive compounds (b) and optionally (d) may be brought to reaction in amounts such that the equivalence ratio of NCO groups of (a) to the sum of the reactive hydrogen atoms of the remaining components is preferably 0.6 to 2.0:1, particularly preferably 0.8 to 1.5:1 and in particular 0.9 to 1.2. The isocyanate index is 100 for a ratio of 1:1.

The reaction to afford the product may be performed for example via high-pressure or low-pressure machines, typically in closed or preferably open molds. Suitable processing machines are commercially available (for example from, inter alia, Elastogran, Isotherm, Hennecke, Kraus Maffei). Depending on the application, the starting components are typically mixed and introduced into the mold, which already contains the covering layer, at a temperature of 0° C. to 100° C., preferably of 20° C. to 80° C. As previously stated the mixing may be performed mechanically using a stirrer or a mixing screw or may be effected in a customary high pressure mixing head. The reaction of the reaction mixture may be performed for example in customary, preferably temperature-controllable and sealable, molds. Molds for producing the products that may be employed include customary and commercially available molds whose surface is for example made of steel, aluminum, enamel, Teflon, epoxy resin or another polymeric material of construction, wherein the surface may optionally be chrome-plated, for example hard-chrome-plated. The molds should preferably be temperature-controllable in order to be able to establish the preferred temperatures, sealable, and preferably equipped to exert a pressure on the product. Customary mold release agents may optionally be employed.

The reaction to afford the polyurethane foams is typically effected at a mold temperature, preferably also at a temperature of the starting components, of 20° C. to 220° C., preferably 30° C. to 120° C., particularly preferably 35° C. to 80° C., for a duration of typically 0.5 to 30 min, preferably 1 to 5 min. In the context of the invention the mixture of the components (a) to (f) at reaction conversions of less than 90% based on the isocyanate groups is described as reaction mixture.

The polyurethane foams obtained have an average thickness averaged over the surface of the covering layer coated with polyurethane foam, wherein regions of the covering layer not coated with polyurethane such as overhanging edge regions are not taken into account in the determination of the average thickness, of not more than one cm, preferably not more than 0.8 and not less than 0.1cm, particularly preferably not more than 0.6 cm and not less than 0.1 cm and in particular not more than 0.5 cm and not less than 0.2 cm.

The present invention further provides a composite element obtainable by the process according to the invention. Despite a low thickness and low polyurethane foam density these composite elements exhibit no defects even when produced in molds with demanding flow characteristics. The composite elements according to the invention are therefore suitable for use in the interior of means of transport, such as in automobiles, for example as a dashboard, door panel, armrest, floor edging, center console, airbag cover or glovebox.

The invention is elucidated hereinbelow with reference to examples.

An instrument panel made of a covering layer of PVC slush skin and a polyurethane foam according to table 1 was produced. To this end the covering layer was inserted into the mold, the polyurethane reaction mixture according to table 1 was mixed by mixing the polyol component composed of polyol, catalyst, DETDA, crosslinker and water with the isocyanate component composed of a mixture of the indicated isocyanates with an isocyanate index of 100 and introduced onto the covering layer. One polyurethane foam having a density of 160 g/l was generated by using 230 g of reaction mixture and one polyurethane foam having a density of 145 g/l was generated by using 200 g of reaction mixture. The mold was then closed. After about 100 seconds the finished composite part was demolded and checked for defects in the polyurethane foam. The following components were employed:

Polyol 1: Glycerol-started polyether polyol based on ethylene oxide and propylene oxide having an average OH number of 28 mg KOH/g, a functionality of 2.7 and a propylene oxide content based on the total weight of the polyether of 84 wt %.

Polyol 2: Glycerol-started polyether polyol based on ethylene oxide and propylene oxide having an average OH number of 27 mg KOH/g, a functionality of 2.5 and a propylene oxide content based on the total weight of the polyether of 78 wt %.

Polyol 3: Glycerol-started polyether polyol based on ethylene oxide and propylene oxide having an average OH number of 55 mg KOH/g, a functionality of 2.7 and a propylene oxide content based on the total weight of the polyether of 87 wt %.

Polyol 4: Propoxylated dimethylaminopropylamine having an average OH number of 250 mg KOH/g, a functionality of 2.0 and a propylene oxide content based on the total weight of the polyether of 72 wt %.

Polyol 5: Polyester composed of adipic acid, 1,4-butanediol, isophthalic acid, monoethylene glycol having an average OH number of 55 mg KOH/g.

Catalyst 1: incorporable amine catalyst Jeffcat® ZF10 from Huntsman

Catalyst 2: incorporable amine catalyst Polycat® 15 from Air Products

Catalyst 3: incorporable amine catalyst Polycat® 58 from Air Products

DETDA: diethyltoluenediamine

Crosslinker: triethanolamine

Iso 1: methylenediphenyl diisocyanate having an NCO content of 33.5 wt % and an average functionality of 2 and a 4,4′ isomer content of 49 wt %

Iso 2: polymethylenediphenyl diisocyanate having an NCO content of 31.5 wt % and an average functionality of 2.7

Iso 3: methylenediphenyl diisocyanate having an NCO content of 33.5 wt % and an average functionality of 2 and a 4,4′ isomer content of 99 wt %

Iso 4: Prepolymer of methylenediphenyl diisocyanate, dipropylene glycol and polyether polyol having an average OH number of 250 mg KOH/g, a functionality of 2 and a propylene oxide content based on the total weight of the polyether of 83 wt %. NCO content of 23 wt % and an average functionality of 2

Iso 5: Mixture of methylenediphenyl diisocyanate and the corresponding carbodiimide having an NCO content of 29.5 wt % and an average functionality of 2.2

TABLE 1

| | Refer- | Exam- | Exam- | Exam- | Exam- |
|---|---|---|---|---|---|
| | ence 1 | ple 1 | ple 2 | ple 3 | ple 4 |
| | wt % | wt % | wt % | wt % | wt % |
| Polyol 1 | 67.0 | 66.1 | 64.8 | 64.8 | 58.0 |
| Polyol 2 | 15.8 | 15.8 | 15.8 | 15.8 | 16.0 |
| Polyol 3 | 10.0 | 9.9 | 9.9 | 9.9 | 10.0 |
| Polyol 4 | 1.0 | 1.0 | 3.0 | 3.0 | 3.0 |
| Polyol 5 | | | | | 6.0 |
| Cat. 1 | 0.4 | 0.4 | 0.4 | 0.4 | 0.4 |
| Cat. 2 | 0.2 | 0.2 | | | |
| Cat. 3 | 0.5 | 0.5 | | | |
| DETDA | | 1.0 | 1.0 | 1.0 | 1.0 |
| Crosslinker | 2.0 | 2.0 | 2.0 | 2.0 | 2.0 |
| Water | 3.1 | 3.1 | 3.1 | 3.1 | 3.1 |
| Color paste | | | | | 0.5 |
| Iso 1 | 50.5 | 50.5 | 50.5 | | |
| Iso 2 | 32.5 | 32.5 | 32.5 | 15.0 | 15.0 |
| Iso 3 | 16.9 | 16.9 | 16.9 | | |
| Iso 4 | | | | 42.5 | 42.5 |
| Iso 5 | | | | 42.5 | 42.5 |
| Index | 100 | 100 | 100 | 100 | 100 |

Table 2 shows the foam quality for the comparative example/the examples 1 to 3 for a foam density of 160 and 145 g/l in each case.

In table 2:

‘Mass’ is to be understood as meaning the mass of the employed polyurethane reaction mixture

In terms of foam stability (foam):

‘poor’ is to be understood as meaning that defects are present in the entire component

‘average’ is to be understood as meaning that defects are present at the edges of the component

‘good’ is to be understood as meaning no defects

TABLE 2

| | Ref 1 | Ref 1 | Ex 1 | Ex 1 | Ex 2 | Ex 2 | Ex 3 | Ex 3 |
|---|---|---|---|---|---|---|---|---|
| Mass | 230 | 200 | 230 | 200 | 230 | 200 | 230 | 200 |
| Density | 160 | 145 | 160 | 145 | 160 | 145 | 160 | 145 |
| Foam | poor | poor | average | poor | good | good | good | good |

The tests show that the use of DETDA makes it possible to improve foam quality. Since DETDA likewise shows catalytic activity, the catalyst content can be reduced compared to a standard formulation (Ref. 1) which results in a further improvement in foam quality (Examples 2 and 3).

1. A process for producing a composite element comprising at least a covering layer and polyurethane foam, the process comprising inserting the covering layer into a mold, introducing a polyurethane reaction mixture onto the covering layer and reacting the polyurethane reaction mixture to form a polyurethane foam, wherein the polyurethane reaction mixture is obtained by mixing
a) polyisocyanate with
b) compounds having isocyanate-reactive OH groups,
c) blowing agents comprising water,
d) thickeners and
e) catalysts
wherein bis(N,N-dimethylaminoethoxyethyl) carbamate, N,N,N-trimethyl-N-hydroxyethylbis(aminopropyl ether), N,N,N-trimethyl-N-hydroxyethyl(aminoethyl ether) or mixtures thereof and/or tetramethyldiaminoethyl ether are employed as catalysts and the polyurethane foam has a density of not more than 200 g/dm³.

2. The process according to claim 1, wherein the polyurethane foam has an average thickness averaged over the surface of the covering layer coated with polyurethane foam of not more than one cm.

3. The process according to claim 1, wherein the thickener (d) is a thickener having two primary or secondary amino groups and a molecular weight of less than 500 g/mol.

4. The process according to claim 3, wherein the amino groups are primary amino groups.

5. The process according to claim 3, wherein the amino groups are bonded to aromatic hydrocarbons.

6. The process according to claim 1, wherein the thickener (d) is diethyltoluenediamine.

7. The process according to claim 1, wherein the isocyanates comprise monomeric and polymeric diphenylmethane diisocyanate.

8. The process according to claim 1, wherein the catalysts (e) comprise incorporable polyurethane catalysts.

9. The process according to claim 8, wherein the incorporable catalysts employed are from the group consisting of: bis(N,N-dimethylaminoethoxyethyl) carbamate, N,N,N-trimethyl-N-hydroxyethylbis(aminopropyl ether), N,N,N-trimethyl-N-hydroxyethyl(aminoethyl ether) and mixtures thereof.

10. The process according to claim 1, wherein the compounds having isocyanate-reactive OH groups (b) comprise polyether polyols.

11. The process according to claim 1, wherein the isocyanate index is 90 to 120.

12. A composite element obtainable by a process according to claim 1.

13. A transport means having an interior comprising a composite element according to claim 12.
